(19) United States
(12) Patent Application Publication
(10) Pub. No.: US 2010/0267278 A1
(43) Pub. Date: Oct. 21, 2010

(54) OUTLET ASSEMBLIES & METHODS OF INSTALLATION THEREOF

(76) Inventor: Jair Gonzalez, New York, NY (US)

Correspondence Address: HPF, P.O. BOX 4442, CHESTERFIELD, MO, 63006-4442, US

(21) Appl. No.: 12/424,530

(22) Filed: Apr. 15, 2009

(51) Int. Cl. H01R 13/60; H01R 13/66

(52) U.S. Cl. 439/535; 439/536

(57) ABSTRACT

Outlet assemblies are provided that include a faceplate having a planar exterior surface, one or more receptacles, a flatrim, and an electrical box. The faceplate is connected to the flatrim (with the one or more receptacles disposed between the faceplate and flatrim). The faceplate, receptacle(s), and flatrim are installed into the electrical box such that the exterior surface of the faceplate is flush with the outer wall that surrounds the electrical box. The flatrim is adapted to be interchangeably connected to, for example, two receptacles or a single receptacle, without having to damage and/or repair the surrounding wall.

### FIELD OF THE INVENTION

The present invention relates generally to the field of wall and ceiling outlets, faceplates and other hardware related thereto, and methods of installing wall and ceiling outlet fixtures.

### BACKGROUND OF THE INVENTION

It is commonplace for walls and ceilings to include electrical outlets, switches, data ports (e.g., for telephone and cable lines), and other types of receptacles. Almost any home or office building today will include, for example, electrical outlets and switches that include an electrical box located within the interior of the wall that supports and is connected to a so-called “mud ring,” to which the electrical outlet or switch may be attached (and then covered by a faceplate).

The currently-available outlet assemblies, however, suffer from several drawbacks. For example, the holes that are cut into a wall, and the mud rings that are connected to the electrical box (or so-called “1900 box”), are configured to only be capable of receiving a receptacle of a certain dimension. That is, for example, the currently-available outlet assemblies are designed such that a wall may not be easily modified to replace an outlet having two receptacles with an outlet having a single receptacle (or an outlet having four receptacles with an outlet having two receptacles), without having to damage and/or repair the surrounding wall area and replace the mud ring.

Furthermore, the hole that is cut into the wall that is adapted to receive the mud ring creates a space that is not sufficient to allow an electrical inspector, during the construction of a new home or building, to conduct an appropriate electrical inspection (as required by local and/or state laws and regulations). As such, the electrical inspections must take place before the dry wall is installed, which often leads to delays in the construction process. In addition, because of the spatial limitations created by conventional mud rings, the electrical wiring must be “pulled” before the mud ring is installed into the wall (and before the dry wall is erected)—which may also contribute to construction delays. Still further, the currently-available outlet assemblies are configured in such a way that the faceplate protrudes outward from the surface of the surrounding wall. This sometimes leads to damaged faceplates and, moreover, does not allow a decorator to paint the faceplate (or the perimeter thereof) in a way that creates a more seamless transition from the wall to the faceplate.

As the following will demonstrate, many of the foregoing problems with currently-available outlet assemblies are addressed by the present invention. Indeed, among the various novel aspects of the present invention, a new “flatrim” assembly is provided, as described herein, which represents a dramatic improvement over and replacement of conventional mud rings.

### SUMMARY OF THE INVENTION

According to certain aspects of the invention, outlet assemblies are provided that include a faceplate having a planar exterior surface, one or more receptacles, a flatrim, and an electrical box. The invention provides that the faceplate is connected to the front portion of the flatrim, with the one or more receptacles disposed between the faceplate and flatrim, and the flatrim is connected to the electrical box. The faceplate, one or more receptacles, and flatrim are installed into the electrical box such that the exterior surface of the faceplate is preferably flush with the outer wall that surrounds the electrical box. According to certain preferred embodiments of the invention, the flatrim is adapted to interchangeably be connected to a variety of different receptacle types. More particularly, for example, the invention provides that the flatrim is configured such that, when the flatrim is attached to an electrical box (e.g., a two-gang electrical box) within a wall, the outlet assembly may be adapted to effectively replace two receptacles with a single receptacle (i.e., make a single receptacle available to a user instead of two), without removing the connected flatrim or damaging (or repairing) the portion of the wall immediately surrounding the flatrim.

According to additional aspects of the invention, a novel flatrim device is provided, as described above. More particularly, according to certain preferred embodiments, the flatrim comprises a front portion that is adapted to be connected to a faceplate having a planar exterior surface, with at least one receptacle disposed between the flatrim and the faceplate. The flatrim further comprises a back portion that is adapted to be connected to an electrical box. As explained above, the invention provides that upon installation of the faceplate, receptacle, and flatrim to the electrical box, the exterior surface of the faceplate is flush with an outer wall that surrounds the electrical box. The invention further provides that the flatrim will, preferably, comprise an outer perimeter having a recessed area located within such outer perimeter. The recessed area is preferably adapted to receive and be connected to the at least one receptacle. In addition, according to certain preferred embodiments, the recessed area of the flatrim may comprise a plurality of apertures, such as three apertures, located in each of a top portion and a bottom portion thereof. For example, the recessed area may be provided with at least three apertures that are spaced an equal distance apart, and are adapted to receive a set of screws that may connect a variety of different receptacle types to the flatrim. For example, as described in greater detail below and by way of illustration only, the apertures may be located within the recessed area of the flatrim in such a way that the associated outlet assembly may be adapted to effectively replace two receptacles with a single receptacle (i.e., make a single receptacle available to a user instead of two), without removing the flatrim from the electrical box or damaging the portion of the wall immediately surrounding the flatrim.

According to other related aspects of the invention, methods for installing an outlet assembly in a wall are provided. More particularly, such methods comprise the steps of cutting a hole in a wall that exhibits approximately the same outer dimension as the outer dimension of the flatrim described herein. The methods further include connecting the flatrim described herein to the electrical box (disposed within the wall), and then connecting the faceplate (which preferably exhibits a planar exterior surface) and a receptacle to the flatrim. As explained above, the faceplate, receptacle, and flatrim are preferably installed into the electrical box in such a manner that the exterior surface of the faceplate is flush with an outer surface of the wall that surrounds the electrical box. The invention provides that the foregoing method will allow an electrical inspector to conduct an electrical inspection of the wires and electrical box, even after the surrounding wall has been erected. More particularly, the present invention will allow an electrician to install the flatrim, and terminate and install the outlet (receptacle) after the dry wall has been erected—and allow an electrical inspector to perform an inspection thereafter, without damaging the dry wall or causing any delays in the construction process.

The above-mentioned and additional features of the present invention are further illustrated in the Detailed Description contained herein.

### BRIEF DESCRIPTION OF THE FIGURES

FIG. 1: A perspective, disassembled view of an outlet assembly of the present invention, which shows a single receptacle being attached to the flatrim.

FIG. 2: A perspective, disassembled view of the outlet assembly of FIG. 1, which shows two receptacles being attached to the flatrim.

FIG. 3: Another perspective view of the outlet assembly of FIG. 2, which shows the flatrim connected to an underlying electrical box.

FIG. 4: A perspective, assembled view of an outlet assembly of the present invention.

FIG. 5: A front, assembled view of an outlet assembly of the present invention, with the perimeter portion thereof covered in drywall tape.

FIG. 6: A perspective, assembled view of the outlet assembly of

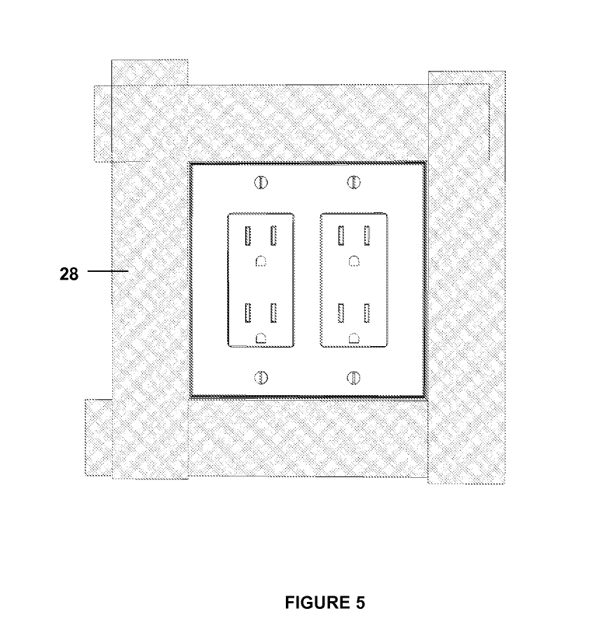

FIG. 5, with the perimeter portion thereof covered in drywall tape, plastered, and painted.

FIG. 7: A perspective, assembled view of the outlet assembly of the present invention, showing a faceplate that exposes four receptacles of a four-gang electrical box.

FIG. 8: A perspective, assembled view of the outlet assembly of FIG. 7, showing a faceplate that exposes two receptacles of the four-gang electrical box.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

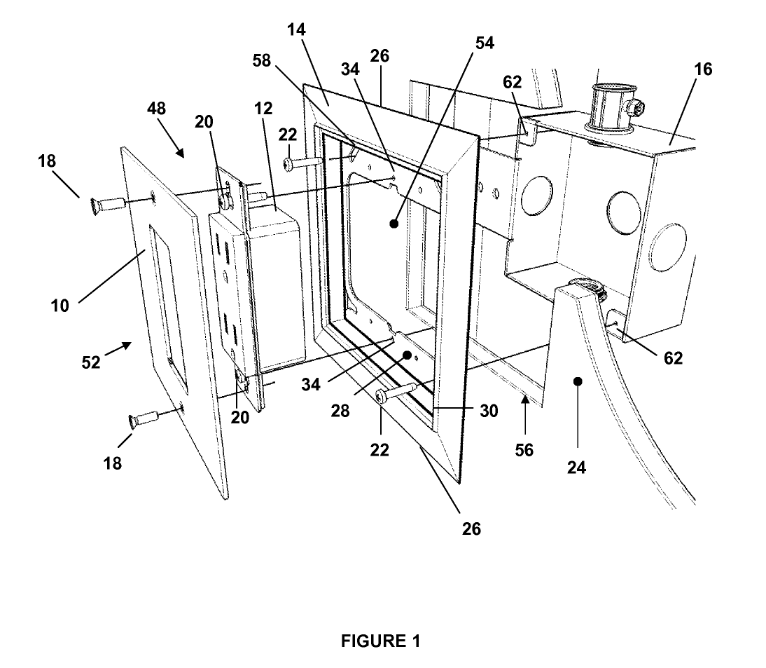

Referring to FIGS. 1-8, according to certain preferred embodiments of the present invention, outlet assemblies are provided that include a faceplate 10 having a planar exterior surface, i.e., the visible surface of the faceplate 10 which faces the interior of a room. The assemblies further comprise one or more receptacles 12, a flatrim 14, and an electrical box 16. A certain type of electrical box 16 is also commonly referred to as a “1900 box” in the field. The electrical box 16 will preferably be attached to a stud within a wall, such that the front plane of the electrical box 16 is flush (or approximately flush) with the front plane of the stud. Preferably, there will be at least a half-inch space between the front plane of the electrical box 16 and the front plane of the dry wall. As used herein, the terms “receptacle” and “receptacles” refer to any of a variety of devices (in any vertical or horizontal configuration) that are commonly disposed within a wall or ceiling and are connected to an electrical box 16, such as electrical outlets (including, but not limited to, outlets that may be disposed in one-gang, two-gang, three-gang, four-gang, five-gang, or six-gang electrical boxes), electrical switches, cable jacks, thermostats, data ports, or even a blank plate.

As illustrated in FIGS. 1-3, the invention provides that the faceplate 10 is connected to the front portion of the flatrim 14, with the one or more receptacles 12 disposed between the faceplate 10 and flatrim 14. The invention provides that the flatrim 14 (or, more particularly, the back portion thereof) is connected to the electrical box 16. Referring to FIG. 1, for example, the invention provides that the faceplate 10 may be connected to the one or more receptacles 12 vis-à-vis a set of screws 18, which are disposed through corresponding apertures located in the top and bottom portions of the faceplate 10 and the receptacle 12. Similarly, the receptacle 12 may be connected to the flatrim 14 vis-à-vis a set of screws 20, which are disposed through corresponding apertures located in the top and bottom portions of the receptacle 12 and the flatrim 14. Still further, the invention provides that the flatrim 14 may be connected to the electrical box 16 vis-à-vis a set of screws 22, which are disposed through corresponding apertures located in the top and bottom portions of the flatrim 14 and the electrical box 16. The invention provides that the flatrim 14 will comprise an outer perimeter 26, which may be tapered and include an inner edge portion 30. The invention provides that the inner edge portion 30 will preferably surround a recessed area 28 (located in the front portion of the flatrim 14), with the recessed area 28 being provided with a set of apertures and adapted to receive and be connected to the receptacle 12, as described herein. The flatrim 14 will further comprise a window area 54 that will allow wires originating from the electrical box 16 to travel through the flatrim 14 and be operably connected with the backside of the receptacle 12.

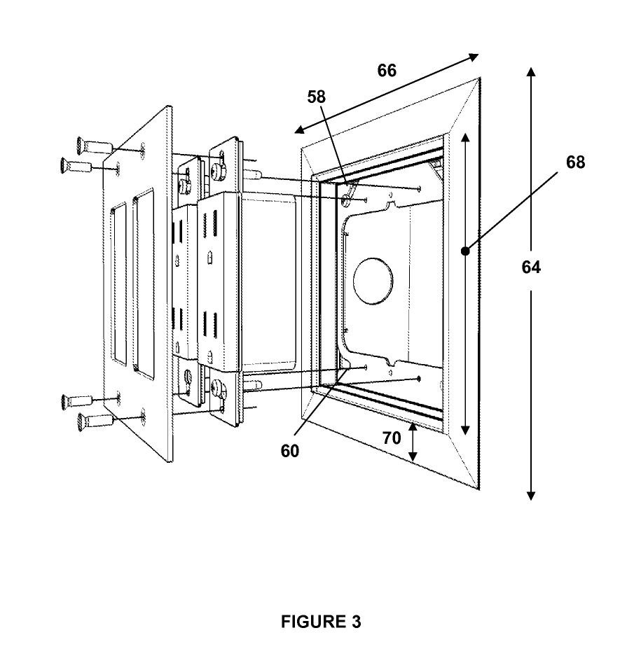

The dimensions of the flatrim 14 may vary to accommodate the size of the electrical box 16. For example, and referring to FIG. 3, the flatrim 14 may be square in shape, and have a height 64 of about 6 inches, and a width 66 of about 6 inches. The tapered outer perimeter 26 may exhibit a height 70 of about 23/32 inches. The inner edge portion 30 of the outer perimeter 26 may exhibit a height 68 (and width) of about 4 and 9/16 inches. Still further, according to certain non-limiting examples of the flatrim 14 described herein, the flatrim 14 may be provided with at least three apertures 32,34,36 located in each of a top portion and a bottom portion of the recessed area 28 thereof (as discussed below), with the at least three apertures 32,34,36 spanning a collective length of about 1 and 13/16 inches (with the apertures of the top portion being located about 3 and ⅜ inches above the apertures of the bottom portion of the recessed area 28). In addition, according to such example, the window area 54 of the flatrim 14 may exhibit a height of 2 and 13/16 inches and a width of 3 and 13/16 inches. The foregoing dimensions are provided for illustration purposes only, as a flatrim 14 which has been shown to be compatible with a two-gang electrical box 16.

In certain preferred embodiments, the invention provides that the apertures located in the top and bottom portions of the flatrim 14, which are used to attach the flatrim 14 to the electrical box 16, will preferably comprise an area that may allow the orientation of the flatrim 14 to be adjusted, before the flatrim 14 is secured to the electrical box 16 using the screws 22 described herein. For example, referring to FIG. 3, the aperture 58 located in the top portion of the flatrim 14 exhibits a slanted column (area), relative to the sides of the flatrim 14, whereas the aperture 60 located in the bottom portion of the flatrim 14 exhibits a column (area) running perpendicular to the side of the flatrim 14. This configuration allows the flatrim 14 to be slightly turned left or right, until the topside of the flatrim 14 is desirably level, while still allowing the apertures 58,60 located in the top and bottom portions of the flatrim 14 to correspond with, and be connected to, the apertures 62 (FIG. 1) located in the electrical box 16. The invention provides that the apertures 58,60 located in the top and bottom portions of the flatrim 14 may be disposed on the left, right, and/or center portions thereof, so long as they correspond with the apertures 62 located in the electrical box 16. This design preferably allows the flatrim 14 to be mounted to a wall in a level fashion, even if the underlying electrical box 16 is not level (which is often the case).

The invention provides that certain of the apertures located in the faceplate 10, receptacle 12, flatrim 14, and electrical box 16 may be threaded, to reversibly and securely receive the applicable set of screws. For example, the apertures located in the top and bottom portion of the receptacle 12, which receive the set of screws 18 that connect the faceplate 10 to the receptacle 12, may be threaded. Likewise, the apertures located in the top and bottom portion of the flatrim 14, which receive the set of screws 20 that connect the receptacle 12 to the flatrim 14, may be threaded. Still further, the apertures 62 located in the top and bottom portion of the electrical box 16, which receive the set of screws 22 that connect the flatrim 14 to the electrical box 16, may be threaded. Although reference is made to such apertures being located in top and bottom portions of the faceplate 10, receptacle 12, flatrim 14, and electrical box 16 described herein, the invention provides that such apertures may, alternatively, be located within other portions of such components. For example, such apertures may be located in the side portions of such components. By way of illustration and not limitation, FIG. 1 depicts corresponding apertures being centered in the top and bottom portions of the faceplate 10 and receptacle 12, whereas the other corresponding apertures are shown to be located in the top-left and bottom-right corners of the flatrim 14 and electrical box 16.

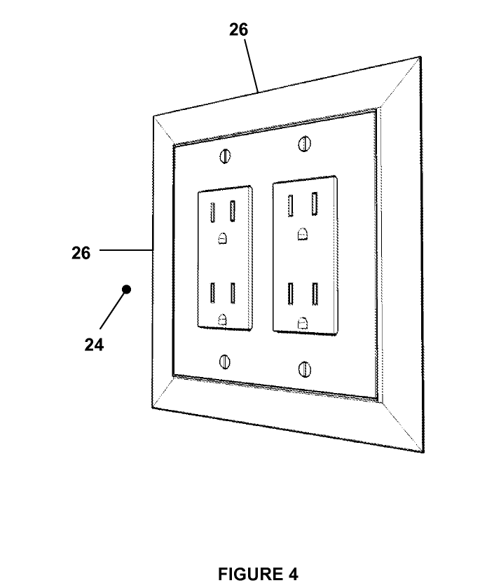

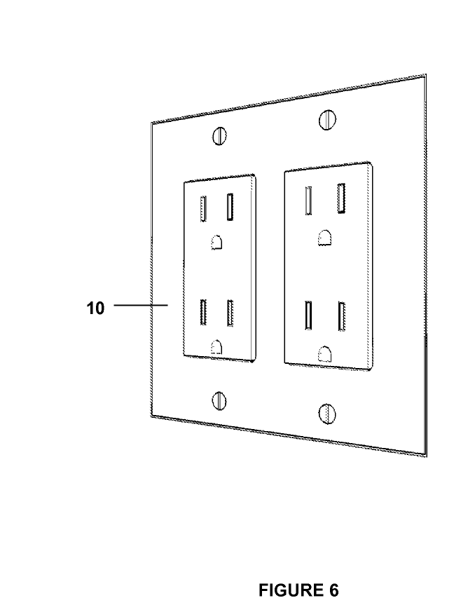

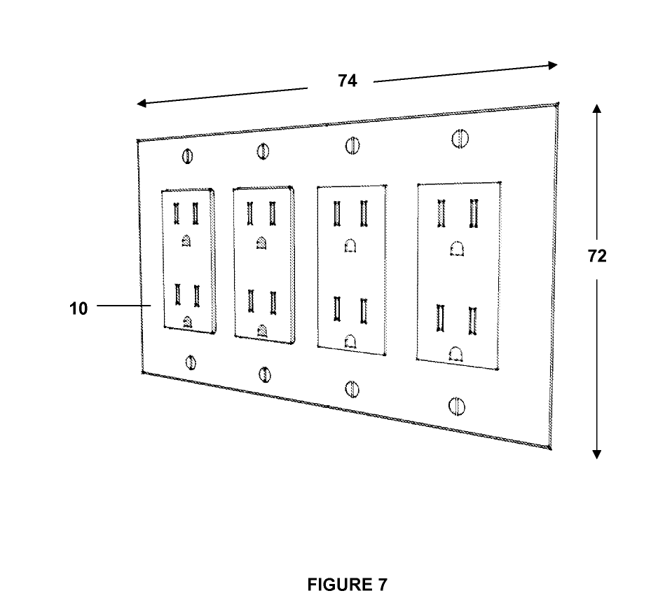

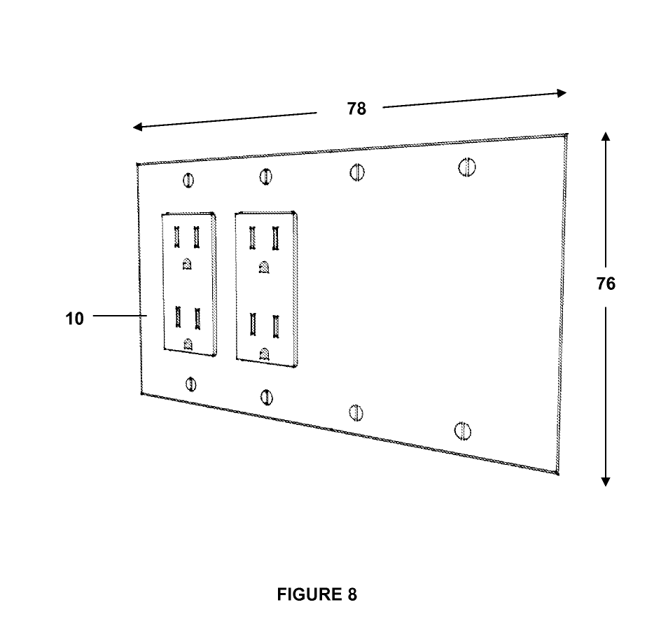

According to certain preferred embodiments of the present invention, the faceplate 10, one or more receptacles 12, and flatrim 14 are installed into the electrical box 16 such that the exterior surface of the faceplate 10 is preferably flush with the outer wall 24 that surrounds the electrical box 16. A non-limiting example of the outlet assemblies described herein is illustrated in FIG. 4, showing the assembly being installed into the wall and the exterior surface of the faceplate 10 being flush with the outer wall 24 that surrounds the electrical box 16. In other words, when installed in the wall and connected to the one or more receptacles 12 and flatrim 14, the exterior surface of the faceplate 10 does not protrude outwards and away from the plane of the wall surface. Rather, the plane of the exterior surface of the faceplate 10 will be substantially contiguous with the plane of the outer wall 24 that surrounds the electrical box 16. As such, referring to FIGS. 4-5, the invention provides that the seam, i.e., the transition point between the outer perimeter (peripheral edge) 26 of the flatrim 14 and the outer wall 24, may be covered with tape, plaster, paint, or a combination thereof 28. Accordingly, if the seam is taped and/or plastered, as illustrated in FIG. 5, the seam (including the tape and/or plaster covering the seam) may be painted to create an appearance whereby the outlet assembly is not only flush with the outer wall, but is also visually seamless with the outer wall. The outlet assembly having a taped, plastered, and painted outer perimeter (peripheral edge) 26 is illustrated in FIG. 6.

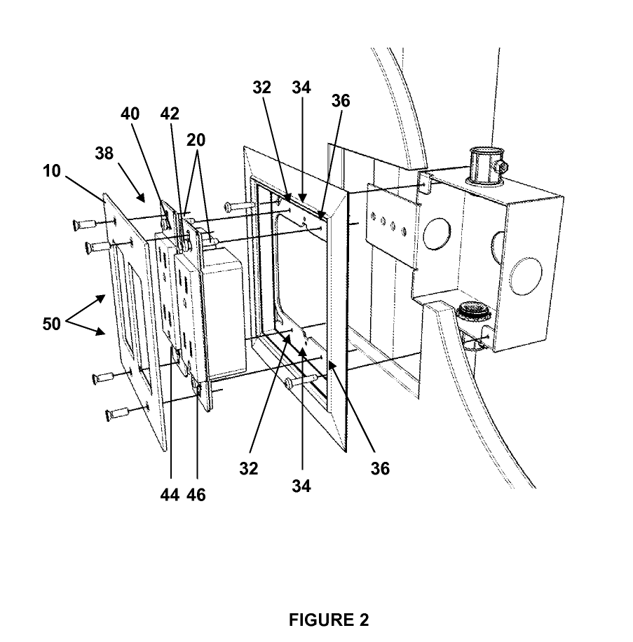

Referring now to FIGS. 1-3, according to certain preferred embodiments of the invention, the flatrim 14 is adapted to interchangeably be connected to a variety of different receptacle types. More particularly, for example, the invention provides that the flatrim 14 is configured such that, when the flatrim 14 is attached to an electrical box 16 within a wall, the outlet assembly may be adapted to effectively replace a four-gang outlet receptacle with a two-gang outlet receptacle (or a two-gang outlet receptacle with a one-gang outlet receptacle), without removing the connected flatrim 14 or damaging and/or repairing the portion of the wall immediately surrounding the flatrim 14. In other words, when the flatrim 14 is attached to an electrical box 16 within a wall, the outlet assembly may be easily transitioned to change the number of accessible receptacles 12 from four receptacles to two receptacles—or from two receptacles to one receptacle. By way of illustration, and referring to FIGS. 1-2, the flatrim 14 may be provided with at least three apertures 32,34,36 located in each of a top portion and a bottom portion of the recessed area 28 of the flatrim 14. The at least three apertures 32,34,36 are preferably spaced an equal distance apart and, as described above, are adapted to receive a set of screws 20 that connect the receptacle 12 to the flatrim 14.

The invention provides, for example, that two receptacles 38 (FIG. 2) having two apertures 40,42 located in a top portion thereof and two apertures 44,46 located in a bottom portion thereof may be reversibly connected to the flatrim 14 vis-à-vis the sets of screws 20 and corresponding apertures located in the recessed area 28 of the flatrim 14. More particularly, in the case of the two receptacles 38 of FIG. 2, a screw 20 is disposed through each of the apertures 40,42 in the top portion of the two receptacles 38, and each such screw is further disposed into a corresponding left and right aperture 32,36 located in the top portion of the flatrim 14. Similarly, a screw 20 is disposed through each of the apertures 44,46 in the bottom portion of the two receptacles 38 and each such screw is further disposed into a corresponding left and right aperture 32,36 located in the bottom portion of the flatrim 14.

In the case of a single receptacle, such as the single receptacle 48 shown in FIG. 1, which includes a single aperture located in a top and bottom portion thereof, a screw 20 may be disposed through the aperture located in the top and bottom portion of the receptacle 48 and further disposed into the center aperture 34 located in the top and bottom portion of the flatrim 14. As shown in FIG. 2, the center aperture 34 is located between the left and right apertures 32,36 of the top and bottom portions of the flatrim 14. Accordingly, the flatrim 14 of the outlet assembly described herein is adapted to interchangeably receive and be connected to either two receptacles 38 (FIG. 2) or a single receptacle 48 (FIG. 1), without having to use a different flatrim 14—and while the flatrim 14 is connected to the electrical box 16 within the outer wall.

For example, if two receptacles 38 are originally affixed to the flatrim 14, the invention provides that one of the two receptacles may be shifted to the right or left (and the other receptacle may be removed), so that the apertures located in the top and bottom portion of the receptacle will correspond and line-up with the center aperture 34 within the flatrim 14 (instead of the left or right apertures 32,36), as illustrated in FIG. 1. For example, referring to FIG. 2, the receptacle that comprises apertures 42,46 may be shifted to the left, so that instead of corresponding with apertures 36 in the flatrim 14, apertures 42,46 will correspond with apertures 34 in the center of the flatrim 14. The receptacle that comprises apertures 40,44 may be removed. The invention further provides that the faceplate 10 that is used to cover the two receptacle 38 shown in FIG. 2, will comprise two separate windows 50 to make the front portion of both receptacles 38 accessible to a user. The invention further provides that the two-window faceplate 10 may be replaced with a faceplate 10 that comprises a single window 52 to make the front portion of the single receptacle 48 of FIG. 1 accessible to a user.

In still other embodiments, instead of disconnecting and removing (and/or moving) a receptacle 12 from the assembly, to reduce the total number of accessible receptacles 12 included in the assembly as described above, the invention provides that different faceplates 10 may be interchangeably used to cover (or reveal) a different number of receptacles 12. For example, referring to FIGS. 7 and 8, a four-gang electrical box 16 (not shown) is affixed to a flatrim 14 (not shown) that may accommodate four receptacles 12. FIG. 7 shows a faceplate 10 having four windows, such that all four receptacles 12 are accessible to a user. If a user wanted to convert the assembly shown in FIG. 7 into an assembly that makes only two receptacles 12 accessible, a different faceplate 10 may be affixed to the assembly, which includes two windows (to render two of the receptacles accessible to a user) and covers the other two receptacles 12, as illustrated in FIG. 8.

The invention provides that the faceplate 10 that is connected to and covers the two receptacles 38 of FIG. 2 will comprise the same outer dimension (e.g., width and height) as the faceplate 10 that is connected to and covers the single receptacle 48 of FIG. 1, with the only difference between the two faceplates being that the faceplate that is connected to the two receptacles 38 of FIG. 2 will comprise two windows 50 through which the receptacles 38 may be accessed, whereas the faceplate 10 that is connected to and covers the single receptacle 48 of FIG. 1 will comprise a single window 52 through which the receptacle 48 may be accessed. Such design is further shown in FIGS. 7 and 8. As illustrated therein, the faceplate 10 of FIG. 7, which comprises four windows to make four receptacles 12 accessible to a user, has a height 72 and width 74 that is the same as the height 76 and width 78 of the faceplate 10 of FIG. 8, which comprises two windows to make two receptacles 12 accessible to a user.

The invention provides that such design allows a user to effectively replace an outlet assembly that provides access to, for example, two receptacles 38 (FIG. 2) with an assembly that provides access to a single receptacle 48 (FIG. 1), or an assembly which provides access to four receptacles (FIG. 7) with an assembly which provides access to two receptacles (FIG. 8), without removing the flatrim 14 or damaging or repairing the area of the wall surrounding the electrical box 16. This represents a substantial improvement over the prior art assemblies, which would otherwise require, for example, that the mud ring (e.g., configured for a two-gang electrical box and two receptacles) used in the conventional outlet assembly be removed and replaced with a new mud ring (configured for a single-gang electrical box and one receptacle). Such a procedure with a prior art outlet assembly would further require that the surrounding wall (drywall) be taped, plastered, and painted to repair the damaged sections thereof (or to otherwise fill-in the gaps that would be created in the wall by replacing a two-gang electrical box with a single-gang electrical box).

Although the Figures in the present application show the flatrim 14 of the device to comprise three apertures 32,34,36 located in the top and bottom portions thereof, the invention provides that a flatrim 14 of other dimensions may be employed. For example, a larger flatrim 14 having 4, 5, 6, or more apertures in the top and bottom portions thereof may be employed (which will exhibit a correspondingly greater width to accommodate the additional apertures). As such, the invention provides that the flatrim 14 described herein may be configured to be connected to, for example, single-gang, two-gang, three-gang, four-gang, five-gang, or six-gang electrical boxes and a corresponding number of receptacles (e.g., outlets, electrical switches, data ports, cable jacks, etc. of varying sizes and numbers). According to such embodiments, as described above, a particular outlet assembly of the present invention could, as desired, be adjusted to provide access to two receptacles (from an assembly that originally provides access to four receptacles), or provide access to four receptacles (from an assembly that originally provides access to six receptacles), or provide access to six receptacles (from an assembly that originally provides access to eight receptacles), and so on. The invention provides, however, that the electrical box 16 should be configured to accommodate (be capable of being connected to) the size of the required flatrim 14, as described herein, which is necessary to receive the largest type and number of receptacles 12 desired. For example, if it is desired to have a maximum of six receptacles (which may be reduced to four or two receptacles as described herein), the electrical box 16 should be sized and configured to be attached to a flatrim 14 that will accommodate a maximum of six receptacles.

Still further, although the Figures in the present application show the flatrim 14 of the device to comprise a rectangular (or square) outer dimension, the invention provides that the flatrim 14 may be configured to exhibit other regular and irregular outer dimensions, provided that the outer dimension of the faceplate is configured in a similar manner. The outlet assemblies described herein, and the components thereof (such as the faceplate 10, receptacle 12, flatrim 14, and electrical box 16), may be comprised of any suitable material, such as plastic, wood, steel, alloys, or combinations thereof. For example, the faceplate 10 may be comprised of wood, steel, brass, copper, or other aesthetically desirable materials; the receptacle 12 may be comprised of a combination of metal and plastic; and the flatrim 14 and electrical box 16 may be comprised of plastic, steel, or other suitable materials.

According to other related embodiments of the invention, methods for installing the outlet assemblies, described herein, in a wall are provided. More particularly, such methods comprise the steps of cutting a hole 56 in a wall that exhibits approximately the same outer dimension as the outer dimension of the flatrim described herein. The methods further include connecting the flatrim described herein to the electrical box, and then connecting the faceplate (which preferably exhibits a planar exterior surface) and a receptacle to the flatrim. As explained above, the faceplate, receptacle, and flatrim are preferably installed into the electrical box in such a manner that the exterior surface of the faceplate is flush with an outer surface of the wall that surrounds the electrical box.

There are many benefits to the present invention. For example, existing conventional prior art outlet assemblies may be replaced (retrofitted) with the outlet assemblies of the present invention, such that the planar surface of the faceplate will be flush with the outer wall—creating a unique and desirable appearance (which may, optionally, be further enhanced by taping, plastering, and painting the seam or transition point between the faceplate and outer wall). Such design will also mitigate the risk of damage to the faceplate, which otherwise may occur with a conventional faceplate that protrudes away from the wall surface. In addition, the flatrim component described herein allows a receptacle and faceplate to be installed into a wall such that the top edge thereof is level, even if the associated electrical box is not level (which is often the case).

Still further, the invention provides that the methods of installing the outlet assemblies of the present invention will allow an electrical inspector to conduct an inspection of the wires and electrical box, even after the surround wall has been erected. In the prior art assemblies, the so-called “mud ring” which is typically used to mount electrical devices to an electrical box does not allow sufficient access to the interior of the electrical box—without damaging the surrounding dry wall—to permit an adequate electrical inspection. As such, when a home is newly constructed, electrical inspections must be performed before the drywall is erected, which often leads to construction delays. Because the flatrim component described above may be easily removed from an electrical box, the outlet assembly described herein allows full access to the interior electrical components, without major repair or damage to surrounding drywall, such that inspections may take place even after the drywall has been erected.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. An outlet assembly, which comprises:
(a) a faceplate having a planar exterior surface;
(b) a receptacle;
(c) a flatrim; and
(d) an electrical box, wherein the faceplate is connected to the flatrim with the receptacle disposed therebetween, wherein the faceplate, receptacle, and flatrim are connected to the electrical box such that the exterior surface of the faceplate is flush with an outer wall that surrounds the electrical box.

2. The outlet assembly of claim 1, wherein the flatrim comprises an outer perimeter with a recessed area located within said outer perimeter, wherein the recessed area is adapted to receive and be connected to the receptacle.

3. The outlet assembly of claim 2, wherein the recessed area of the flatrim comprises at least three apertures located in each of a top portion and a bottom portion thereof, wherein the at least three apertures are spaced an equal distance apart and are adapted to receive a set of screws that connect the receptacle to the flatrim.

4. The outlet assembly of claim 3, wherein the flatrim is adapted to interchangeably receive and be connected to:
(a) a set of two receptacles having two apertures located in a top portion thereof and two apertures located in a bottom portion thereof, wherein (i) a screw is disposed through each of the apertures in the top portion of the set of two receptacles, and each such screw is further disposed into a corresponding left and right aperture located in the top portion of the flatrim and (ii) a screw is disposed through each of the apertures in the bottom portion of the set of two receptacles and each such screw is further disposed into a corresponding left and right aperture located in the bottom portion of the flatrim; or
(b) a single receptacle having a single aperture located in a top portion thereof and a single aperture located in a bottom portion thereof, wherein (i) a screw is disposed through the aperture located in the top portion of the single receptacle and further disposed into a center aperture located in the top portion of the flatrim, which is located between the left and right aperture of the top portion of the flatrim and (ii) a screw is disposed through the aperture located in the bottom portion of the single receptacle and further disposed into a center aperture located in the bottom portion of the flatrim, which is located between the left and right aperture of the bottom portion of the flatrim.

5. The outlet assembly of claim 4, wherein the flatrim is adapted to interchangeably receive and be connected to the set of two receptacles or single receptacle while the flatrim is connected to the electrical box within the outer wall.

6. The outlet assembly of claim 5, wherein:
(a) a faceplate that is connected to the flatrim and the set of two receptacles will comprise the same outer dimension as a faceplate that is connected to the flatrim and single receptacle;
(b) the faceplate that is connected to the set of two receptacles will comprise two windows through which each of the two receptacles may be accessed; and
(c) the faceplate that is connected to the single receptacle will comprise a single window through which the single receptacle may be accessed.

7. The outlet assembly of claim 6, wherein the outer perimeter of the flatrim is tapered, wherein a transition point between the outer perimeter and the outer wall is covered with tape, plaster, paint, or a combination thereof.

8. A flatrim device which comprises:
(a) a front portion that is adapted to be connected to a faceplate having a planar exterior surface, with at least one receptacle disposed between the flatrim and faceplate; and
(b) a back portion that is adapted to be connected to an electrical box, wherein upon installation of the faceplate, receptacle, and flatrim to the electrical box, the exterior surface of the faceplate is flush with an outer wall that surrounds the electrical box.

9. The flatrim device of claim 8, wherein the flatrim comprises an outer perimeter with a recessed area located within said outer perimeter, wherein the recessed area is adapted to receive and be connected to the at least one receptacle.

10. The flatrim device of claim 9, wherein the recessed area of the flatrim comprises at least three apertures located in each of a top portion and a bottom portion thereof, wherein the at least three apertures are spaced an equal distance apart and are adapted to receive a set of screws that connect the at least one receptacle to the flatrim.

11. The flatrim device of claim 10, wherein the flatrim is adapted to interchangeably receive and be connected to:
(a) a set of two receptacles having two apertures located in a top portion thereof and two apertures located in a bottom portion thereof, wherein (i) a screw is disposed through each of the apertures in the top portion of the set of two receptacles, and each such screw is further disposed into a corresponding left and right aperture located in the top portion of the flatrim and (ii) a screw is disposed through each of the apertures in the bottom portion of the set of two receptacles and each such screw is further disposed into a corresponding left and right aperture located in the bottom portion of the flatrim; or
(b) a single receptacle having a single aperture located in a top portion thereof and a single aperture located in a bottom portion thereof, wherein (i) a screw is disposed through the aperture located in the top portion of the single receptacle and further disposed into a center aperture located in the top portion of the flatrim, which is located between the left and right aperture of the top portion of the flatrim and (ii) a screw is disposed through the aperture located in the bottom portion of the single receptacle and further disposed into a center aperture located in the bottom portion of the flatrim, which is located between the left and right aperture of the bottom portion of the flatrim.

12. The flatrim device of claim 11, wherein the flatrim is adapted to interchangeably receive and be connected to the set of two receptacles or single receptacle while the flatrim is connected to the electrical box within the outer wall.

13. The flatrim device of claim 12, wherein:
(a) a faceplate that is connected to the flatrim and the set of two receptacles will comprise the same outer dimension as a faceplate that is connected to the flatrim and single receptacle;
(b) the faceplate that is connected to the set of two receptacles will comprise two windows through which each of the two receptacles may be accessed; and
(c) the faceplate that is connected to the single receptacle will comprise a single window through which the single receptacle may be accessed.

14. The flatrim device of claim 13, wherein the outer perimeter of the flatrim is tapered, wherein a transition point between the outer perimeter and the outer wall is covered with tape, plaster, paint, or a combination thereof.

15. A method for installing an outlet assembly in a wall, which comprises the steps of:
(a) cutting a hole in a wall, wherein the hole (i) will comprise an outer dimension that is approximately the same as an outer dimension of a flatrim and (ii) will be centered around at least one electrical box located within an interior portion of the wall;
(b) connecting the flatrim to the electrical box; and
(c) connecting a faceplate having a planar exterior surface and a receptacle to the flatrim, wherein the faceplate is connected to the flatrim with the receptacle disposed therebetween, wherein the faceplate, receptacle, and flatrim are installed into the electrical box such that the exterior surface of the faceplate is flush with an outer surface of the wall that surrounds the electrical box.

16. The method of claim 15, wherein the flatrim that is connected to the electrical box comprises an outer perimeter with a recessed area located within said outer perimeter, wherein the recessed area is adapted to receive and be connected to the receptacle.

17. The method of claim 16, wherein the flatrim that is connected to the electrical box is adapted to interchangeably be connected to and provide access to either a set of two receptacles or a single receptacle by:
(a) providing a set of two receptacles having two apertures located in a top portion thereof and two apertures located in a bottom portion thereof, wherein (i) a screw is disposed through each of the apertures in the top portion of the set of two receptacles, and each such screw is further disposed into a corresponding left and right aperture located in the top portion of the flatrim and (ii) a screw is disposed through each of the apertures in the bottom portion of the set of two receptacles and each such screw is further disposed into a corresponding left and right aperture located in the bottom portion of the flatrim; or
(b) providing a single receptacle having a single aperture located in a top portion thereof and a single aperture located in a bottom portion thereof, wherein (i) a screw is disposed through the aperture located in the top portion of the single receptacle and further disposed into a center aperture located in the top portion of the flatrim, which is located between the left and right aperture of the top portion of the flatrim and (ii) a screw is disposed through the aperture located in the bottom portion of the single receptacle and further disposed into a center aperture located in the bottom portion of the flatrim, which is located between the left and right aperture of the bottom portion of the flatrim.

18. The method of claim 17, wherein the flatrim receives and is connected to the set of two receptacles or single receptacle while the flatrim is connected to the electrical box within the wall.
